(19) United States
(12) Patent Application Publication
(10) Pub. No.: US 2025/0183386 A1
(43) Pub. Date: Jun. 5, 2025

(54) APPARATUS FOR DEACTIVATING BATTERY MODULE, BATTERY PACK INCLUDING THE SAME, AND METHOD OF DEACTIVATING BATTERY MODULE

(71) Applicant: SAMSUNG SDI CO., LTD., Yongin-si (KR)

(72) Inventor: Min Su KIM, Suwon-si (KR)

(21) Appl. No.: 18/805,586

(22) Filed: Aug. 15, 2024

(30) Foreign Application Priority Data
Dec. 5, 2023 (KR) 10-2023-0174429

(51) Int. Cl. H01M 10/42; H01M 50/583; H02H 7/18

(52) U.S. Cl. CPC H01M 10/4264; H01M 50/583; H02H 7/18; H01M 2010/4271; H01M 2200/103

(57) ABSTRACT

The present disclosure relates to an apparatus for deactivating a battery module, a battery pack including the same, and a method of deactivating the battery module. The apparatus can selectively deactivate a battery module, a battery pack includes the apparatus, and a method of deactivating the module using such an apparatus. The apparatus for deactivating a module includes a relay connected to a first electrode terminal and a second electrode terminal of a battery module, a fuse circuit connected to the first electrode terminal and a first electrode of a battery cell array, and a processor configured to control the fuse circuit when a preset condition is satisfied to block a current path between the first electrode terminal and the first electrode and short the relay.

### CROSS-REFERENCE TO RELATED APPLICATION

This application claims priority to and the benefit of Korean Patent Application No. 10-2023-0174429, filed on Dec. 5, 2023, the disclosure of which is incorporated herein by reference in its entirety.

### BACKGROUND

### 1. Field

Aspects of embodiments of the present disclosure relates to an apparatus for deactivating a battery module that may selectively deactivate a battery module, a battery pack including the same, and a method of deactivating the battery module.

### 2. Discussion of the Related Art

A secondary battery is a battery which can be charged and discharged, which is unlike a primary battery that cannot be recharged. Low-capacity secondary batteries are used in small, portable electronic devices such as smartphones, feature phones, notebook computers, digital cameras, and camcorders. High-capacity secondary batteries are widely used as power sources for driving motors, batteries for storing power, in hybrid vehicles, in electric vehicles, and the like. A secondary battery includes an electrode assembly including a positive electrode and a negative electrode, a case accommodating the electrode assembly, an electrode terminal connected to the electrode assembly, and the like.

Rechargeable batteries can be used as battery modules that are each formed of a plurality of unit battery cells connected in series and/or parallel to provide a high energy density, for example, for driving a motor of a hybrid vehicle. In other words, a battery module is formed by interconnecting electrode terminals of a plurality of unit battery cells according to the amount of power required to implement, for example, a high-power rechargeable battery for an electric vehicle. In order to constitute a battery pack, one or more battery modules are mechanically and electrically integrated.

A battery module has a limited lifetime due to degradation and can become unusable due to a failure. In addition, defective battery modules can be included in a battery pack due to errors in a manufacturing process. Failed battery modules can cause a failure of the battery pack, which can lead to accidents. Therefore, there is a need to quickly replace a battery module that has failed, but there is a problem in that the replacement of the battery module requires time and significant cost.

Therefore, there is a need for a technology for quickly eliminating a risk of defective battery modules included in a battery pack at low cost.

The above-described information disclosed in the background technology is only for improving the understanding for the background of the present disclosure, and thus may include information not constituting the related art.

### SUMMARY

The present disclosure is directed to providing an apparatus for deactivating a module capable of selectively deactivating a battery module, a battery pack including the same, and a method of deactivating the module.

However, the object of the present disclosure is not limited to the above-described object, and other objects that are not mentioned will be able to be clearly understood by those skilled in the art from the following description.

An apparatus for deactivating a module according to one embodiment of the present disclosure deactivates a battery module by blocking a current path between a terminal of a battery module and a battery cell array through a fuse circuit connected to a first electrode terminal of the battery module and a first electrode of the battery cell array and shorting a relay connected to the first electrode terminal and a second electrode terminal of the battery module.

According to one embodiment an apparatus is provided for deactivating a battery module. The apparatus comprising a relay configured to be connected to a first electrode terminal and a second electrode terminal of a battery module; a fuse circuit configured to be connected to the first electrode terminal and a first electrode of a battery cell array; and a processor connected to the relay and the fuse circuit. When a preset condition is satisfied, the processor is configured to control the fuse circuit to block a current path between the first electrode terminal and the first electrode and short the relay.

According to another embodiment, a method of deactivating a battery module, is performed by a computing device including a processor. The method comprises blocking a current path between a first electrode terminal of a battery module and a first electrode of a battery cell array by controlling a fuse circuit connected to the first electrode terminal and the first electrode when a preset condition is satisfied; and shorting a relay connected to the first electrode terminal and a second electrode terminal of the battery module.

According to a further embodiment, a battery pack comprises a plurality of battery modules; and a battery management system configured to manage the plurality of battery modules. The battery management system identifies a target battery module to be deactivated among the plurality of battery modules and outputs a module deactivation signal to the target battery module. The battery module is deactivated by being shorted upon receiving the module deactivation signal.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an apparatus for deactivating a module.

FIG. 2 illustrates a housing of the apparatus for deactivating the module.

FIG. 3 illustrates a method of deactivating the module.

FIG. 4 illustrates a battery pack.

FIG. 5 illustrates a method of operating the battery pack.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

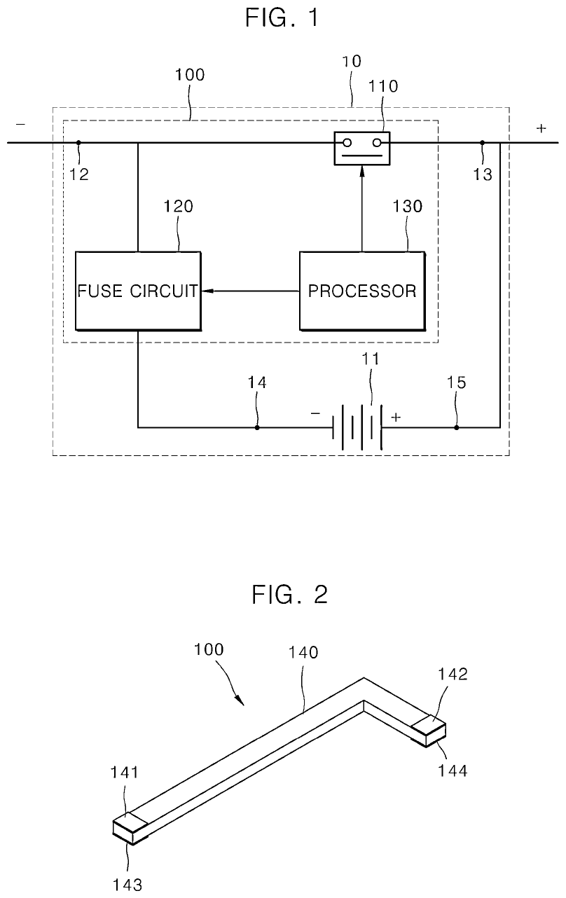

FIG. 1 illustrates an apparatus for deactivating a module according to one embodiment of the present disclosure, and FIG. 2 illustrates a housing of the apparatus for deactivating the module according to one embodiment of the present disclosure.

Referring to FIGS. 1 and 2, an apparatus 100 for deactivating a module may include a relay 110, a fuse circuit 120, a memory (not illustrated), a processor 130, and a housing 140.

The apparatus 100 for deactivating a module may be provided in a module housing of a battery module 10. For example, the apparatus 100 for deactivating the module may be provided between a battery cell array 11 (or a bus bar configured to connect a plurality of battery cells) and a module housing cover.

The relay 110 may be connected to a first electrode terminal 12 of the battery module 10 and a second electrode terminal 13 of the battery module 10. When the first electrode terminal 12 of the battery module 10 is a positive electrode terminal, the second electrode terminal 13 of the battery module 10 is a negative electrode terminal. When the first electrode terminal 12 of the battery module 10 is the negative electrode terminal, the second electrode terminal 13 of the battery module 10 is the positive electrode terminal.

The positive electrode terminal (or a tab) of the battery module 10 may be provided on the module housing cover to enable an electrical connection with an external device. The positive electrode terminal of the battery module 10 may be electrically connected to a positive electrode of the battery cell array 11. Here, the battery cell array 11 may refer to a set of battery cells connected in series or parallel.

The negative electrode terminal (or a tab) of the battery module 10 may be provided on the module housing cover to enable an electrical connection with an external device. The negative electrode terminal of the battery module 10 may be electrically connected to a negative electrode of the battery cell array 11.

The relay 110 may have one end connected to the first electrode terminal 12 of the battery module 10 and the other end connected to the second electrode terminal 13 of the battery module 10. The relay 110 may be disconnected or shorted under the control of the processor 130.

The relay 110 may be shorted to form a bypass circuit in which the first electrode terminal 12 of the battery module 10 is directly connected to the second electrode terminal 13 of the battery module 10. When the relay 110 is shorted, a current flows through a current path formed by the bypass circuit. The relay 110 may be disconnected to block a connection between the first electrode terminal 12 and the second electrode terminal 13 of the battery module 10. When the relay 110 is disconnected, the current path formed by the bypass circuit is blocked.

The fuse circuit 120 may be connected to the first electrode terminal 12 of the battery module 10 and a first electrode 14 of the battery cell array 11. Here, the first electrode 14 of the battery cell array 11 may be an electrode with the same polarity as the first electrode terminal 12 among the electrodes (positive electrode and negative electrode) of the battery cell array 11.

More specifically, the positive electrode of the battery cell array 11 may be the positive electrode terminal provided in the cell housing of the battery cell positioned at a first or last position based on a layout of the circuit among the battery cells included in the battery cell array 11. The negative electrode of the battery cell array 11 may be the negative electrode terminal provided in the cell housing of the battery cell positioned at a first or last position based on a layout of the circuit among the battery cells included in the battery cell array 11. In this case, when the positive electrode terminal provided in the cell housing of the battery cell positioned at the first position is the positive electrode of the battery cell array 11, the negative terminal provided in the cell housing of the battery cell positioned at the last position is the negative electrode of the battery cell array 11.

For example, when the first electrode terminal 12 of the battery module 10 is the positive electrode terminal, the first electrode 14 of the battery cell array 11 is a positive electrode. In this case, the fuse circuit 120 is connected to the positive electrode terminal of the battery module 10 and the positive electrode of the battery cell array 11. When the first electrode terminal 12 of the battery module 10 is the negative electrode terminal, the first electrode 14 of the battery cell array 11 is a negative electrode. In this case, the fuse circuit 120 is connected to the negative electrode terminal of the battery module 10 and the negative electrode of the battery cell array 11.

The fuse circuit 120 may operate under the control of the processor 130 to block a current path formed by a circuit provided with the fuse circuit 120. When the fuse circuit 120 operates, a current path formed by a circuit in which the first electrode terminal 12 of the battery module 10 is connected to the first electrode 14 of the battery cell array 11 is blocked.

The fuse circuit 120 may include a fuse, a capacitor, and a switch element. The fuse may have one end connected to the first electrode terminal 12 of the battery module 10 and the other end connected to the first electrode 14 of the battery cell array 11. The capacitor may be connected to the fuse. For example, the capacitor may be connected to the fuse in parallel. The capacitor may store a voltage with a sufficient magnitude. Here, the voltage with the sufficient magnitude may be a voltage higher than a rated voltage of the fuse.

The switch element may be connected to the fuse and the capacitor. For example, the switch element may be connected to the capacitor in series. The switch element may be a transistor, but is not limited thereto. The switch element may be turned on or off under the control of the processor 130. When the switch element is turned on, the voltage stored in the capacitor may be applied to the fuse, and thus the fuse may be melted and disconnected.

At least one command to be executed by the processor 130 may be stored in the memory. The memory may be implemented as a volatile storage medium and/or non-volatile storage medium and implemented as, for example, a read-only memory (ROM) and/or a random access memory (RAM).

The processor 130 may be operatively connected to the relay 110, the fuse circuit 120, and the memory. The processor 130 may be implemented as a central processing unit (CPU) or system on chip (SOC), may control a plurality of hardware or software components connected to the processor 130 by driving an operating system or application, and perform processing and calculation on various types of data. The processor 130 may be configured to execute at least one command stored in the memory and store execution result data in the memory.

When a preset condition is satisfied, the processor 130 may control the fuse circuit 120 to block the current path between the first electrode terminal 12 of the battery module 10 and the first electrode 14 of the battery cell array 11 and short the relay 110. Here, the preset condition may be when a module deactivation signal is received from a battery management system. In other words, the processor 130 may deactivate the battery module 10 by shorting the battery module 10 when receiving the module deactivation signal.

The housing 140 may accommodate the relay 110, the fuse circuit 120, the memory, and the processor 130. The housing 140 may perform a function of protecting the relay 110, the fuse circuit 120, the memory, and the processor 130 from foreign substances and impacts. A specific shape of the housing 140 is not limited to the shape illustrated in FIG. 2, and various design changes are possible as long as the shape of the housing 140 can be accommodated in the battery module 10.

The housing 140 may be provided with first to fourth contact terminals 141 to 144. The first contact terminal 141 may be connected to the first electrode terminal 12 provided on the module housing cover. The first contact terminal 141 may be provided in an area corresponding to the first electrode terminal 12 provided on the module housing cover of an upper area of the housing 140. For example, the first contact terminal 141 may be provided under the first electrode terminal 12 provided on the module housing cover. The first contact terminal 141 may be electrically connected to the relay 110 and the fuse circuit 120.

The second contact terminal 142 may be connected to the second electrode terminal 13 provided on the module housing cover. The second contact terminal 142 may be provided in an area corresponding to the second electrode terminal 13 provided on the module housing cover of the upper area of the housing 140. For example, the second contact terminal 142 may be provided under the second electrode terminal 13 provided on the module housing cover. The second contact terminal 142 may be electrically connected to the relay 110 and the fourth contact terminal 144.

The third contact terminal 143 may be connected to the first electrode 14 of the battery cell array 11. The third contact terminal 143 may be connected to an electrode with the same polarity as that of the first electrode 14 of the battery cell array 11 among the electrodes of the bus bar configured to connect the plurality of battery cells. The third contact terminal 143 may be provided in an area corresponding to the first electrode 14 of the battery cell array 11 of a lower area of the housing 140. For example, the third contact terminal 143 may be provided above the first electrode 14 of the battery cell array 11. The third contact terminal 143 may be electrically connected to the fuse circuit 120 and the first electrode 14 of the battery cell array 11.

The fourth contact terminal 144 may be connected to the second electrode 15 of the battery cell array 11. The fourth contact terminal 144 may be connected to an electrode with the same polarity as that of the second electrode 15 of the battery cell array 11 among the electrodes of the bus bar configured to connect the plurality of battery cells. The fourth contact terminal 144 may be provided in an area corresponding to the second electrode 15 of the battery cell array 11 of the lower area of the housing 140. For example, the fourth contact terminal 144 may be provided above the second electrode 15 of the battery cell array 11. The fourth contact terminal 144 may be electrically connected to the second electrode 15 of the battery cell array 11 and the second contact terminal 142.

Although the fuse circuit 120 described above is connected to only one of the electrode terminals (positive electrode terminal and negative electrode terminal) of the battery module 10, the apparatus 100 for deactivating the module may be configured so that the fuse circuit 120 is connected to each of the electrode terminals of the battery module 10. In this case, each fuse circuit 120 may operate in the same manner.

Based on the above description, a method of deactivating the module according to one embodiment of the present disclosure will be described below in detail focusing on the operation of the processor 130.

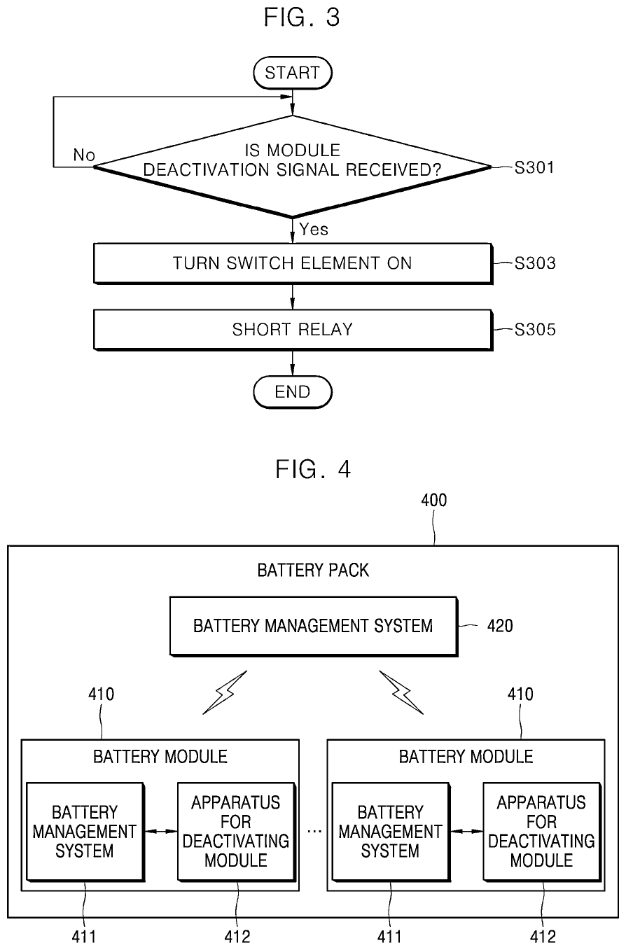

FIG. 3 illustrates a method of deactivating the module according to one embodiment of the present disclosure.

Referring to FIG. 3, first, the processor 130 determines whether a module deactivation signal has been received (S301). The module deactivation signal is a signal generated by a battery management system (BMS) and may be a signal instructing the deactivation of the battery module. The module deactivation signal may include a preset binary string. For example, the module deactivation signal may include a binary string with a length of 128 bits or more. In the present embodiment, by forming the deactivation signal consisting of a highly complex binary string, it is possible to effectively prevent the battery module from being deactivated by any noise or signal. Meanwhile, the BMS may identify a defective battery module among the plurality of battery modules included in a battery pack and transmit the module deactivation signal to the identified battery module.

Upon receiving the module deactivation signal, the processor 130 turns on the switch element included in the fuse circuit 120 (S303). When the switch element included in the fuse circuit 120 is turned on, the voltage stored in the capacitor included in the fuse circuit 120 may be applied to the fuse, and, thus, the fuse melts and is disconnected. As the fuse is melts and disconnects, the current path formed by the circuit in which the first electrode terminal 12 of the battery module is connected to the first electrode 14 of the battery cell array 11 is blocked.

Subsequently, the processor 130 may short the relay 110 (S305). When the relay 110 is shorted, the bypass circuit in which the first electrode terminal 12 of the battery module is connected to the second electrode terminal 13 of the battery module is formed, and a current flows through the bypass circuit.

As described above, when the switch element is turned on and the relay 110 is shorted, as the battery cell array 11 is electrically separated from the electrode terminals of the battery module, a current sequentially flowing through the positive electrode of the battery module, the battery cell array 11, and the negative electrode of the battery module may sequentially flow through the positive electrode of the battery module and the negative electrode of the battery module, thereby deactivating the battery module.

Meanwhile, when power is stored in the battery module, there is still potential danger even when the battery module is deactivated. Therefore, in order to reduce the risk associated with the deactivated battery module, it is necessary to discharge the power stored in the deactivated battery module.

Therefore, the processor 130 may externally output a control signal instructing passive balancing for the battery module after operation S305. The control signal instructing the passive balancing may be transmitted to a module BMS included in the battery module. When receiving the control signal transmitted from the processor 130, the module BMS may safely discharge the power stored in the battery cell array 11 by performing the passive balancing.

FIG. 4 illustrates a battery pack according to one embodiment of the present disclosure.

Referring to FIG. 4, a battery pack 400 may include a plurality of battery modules 410 and a BMS 420. The battery pack 400 may include a pack housing in which an accommodating space accommodating the plurality of battery modules 410 is formed. It goes without saying that the battery pack 400 may include further components in various embodiments.

Each battery module 410 may include a plurality of battery cells and a module housing, with the plurality of battery cells connected in series or parallel. The battery modules 410 may be connected in series or parallel.

The battery cells may be accommodated inside the module housing in a stacked form. Each battery cell may include a positive electrode lead and a negative electrode lead. Depending on the battery type, a circular, prismatic, or pouch type battery cell may be used.

In the battery pack 400, one cell stack instead of the battery module 410 may form one module. The cell stack may be accommodated in an accommodating space of the pack housing or accommodated in an accommodating space partitioned by a frame, a partition, or the like.

The battery cell generates a large amount of heat during charging/discharging. The generated heat accumulates in the battery cells and accelerates the degradation of the battery cells. Therefore, the battery pack 400 may further include a cooling member to suppress the degradation of the battery cells. The cooling member may be provided on a lower portion of the accommodating space in which the battery cells are provided, but is not limited thereto, and may be provided on an upper portion or side surface thereof depending on the battery pack 400.

Exhaust gases inside the battery cells generated under abnormal operating conditions, also known as a thermal runaway or thermal event of the battery cell, may be discharged to the outside of the battery cell. The battery pack 400 or battery modules 410 may include an exhaust port or the like for discharging the exhaust gases to suppress damage to the battery pack 400 or module.

Each battery module 410 may include a module BMS 411 and an apparatus 412 for deactivating the module.

The module BMS 411 may manage the battery module 410. The module BMS 411 may detect a state (a voltage, a current, a temperature, and the like) of the battery module 410 and detect state information indicating the state of the battery module 410.

The module BMS 411 may detect a state (a voltage, a current, a temperature, and the like) of each battery cell constituting the battery module 410 and detect the state information indicating the state of each battery cell.

The module BMS 411 may perform a balancing operation of the battery cells included in the battery module 410. For example, the module BMS 411 may perform the passive balancing operation.

The apparatus 412 for deactivating the module may selectively deactivate the battery module 410. The apparatus 412 for deactivating the module may deactivate the battery module 410 by shorting the battery module 410. The apparatus 412 for deactivating the module may deactivate the battery module 410 upon receiving the module deactivation signal from the BMS 420.

The BMS 420 may manage the battery pack 400. The BMS 420 may detect a state (a voltage, a current, a temperature, and the like) of the battery pack 400 and detect state information indicating the state of the battery pack 400. The BMS 420 may detect a state (a voltage, a current, a temperature, and the like) of each battery module 410 constituting the battery pack 400 and detect the state information indicating the state of each battery module 410.

The BMS 420 may communicate with the module BMS 411 included in each battery module 410 in a wired and/or wireless manner. The BMS 420 may receive and process data transmitted from each module BMS 411. The BMS 420 may transmit data to the module BMS 411. The BMS 420 may communicate with an external device in a wired and/or wireless manner. For example, the BMS 420 may be connected to each battery module 410 (in particular, the apparatus 412 for deactivating the module) via a differential universal asynchronous receiver-transmitter (Diff-UART) cable.

The BMS 420 may identify the defective battery module 410 among the plurality of battery modules 410 included in the battery pack 400 based on at least one of the state information of the battery cell, the state information of the battery module 410, and the state information of the battery pack 400. The BMS 420 may receive identification information about the defective battery module 410 from an external device.

Based on the above description, a method of operating a battery pack according to one embodiment of the present disclosure will be described below.

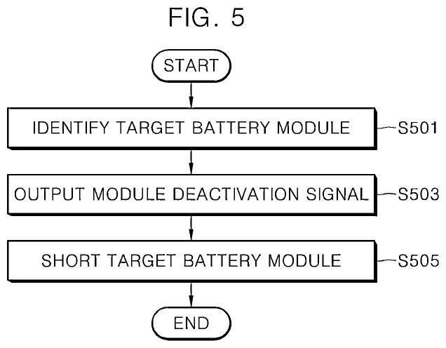

FIG. 5 illustrates a method of operating a battery pack according to one embodiment of the present disclosure.

Referring to FIG. 5, first, the BMS 420 identifies a target battery module to be deactivated among the plurality of battery modules 410 included in the battery pack 400 (S501). That is, in operation S501, the BMS 420 identifies a defective battery module as the target battery module.

Subsequently, the BMS 420 outputs the module deactivation signal to the target battery module (S503). The module deactivation signal is a signal instructing the deactivation of the battery module 410.

Subsequently, the target battery module is deactivated by the apparatus 412 for deactivating the module upon receiving the module deactivation signal (S505). The target battery module is deactivated by controlling the fuse circuit 120 included in the apparatus 412 for deactivating the module to block the current path between the first electrode terminal 12 of the battery module 410 and the first electrode 14 of the battery cell array 11 and short the relay 110 included in the apparatus 412 for deactivating the module.

As described above, according to the present disclosure, by selectively deactivating the defective battery module among the battery modules included in the battery pack, it is possible to improve the stability of the battery pack.

According to the present disclosure, by minimizing the influence of the deactivated battery module on the other battery modules included in the battery pack, it is possible to prevent the degradation in the performance of the entirety of the battery pack due to the deactivated battery module.

According to the present disclosure, by safely discharging the power stored in the deactivated battery module, it is possible to prevent the occurrence of an accident due to the deactivated battery module.

According to one aspect of the present disclosure, by selectively deactivating a defective battery module among battery modules included in a battery pack, the stability of the battery pack can be improved.

According to one aspect of the present disclosure, by minimizing the influence of a deactivated battery module on other battery modules included in the battery pack, the degradation in performance of the entirety of the battery pack due to the deactivated battery module can be prevented.

According to one aspect of the present disclosure, by safely discharging power stored in the deactivated battery module, the occurrence of an accident due to the deactivated battery module can be prevented.

However, effects which can be obtained through the present disclosure are not limited to the above-described effects, and other effects that are not mentioned will be clearly understood by those skilled in the art from the description herein.

What is claimed is:

1. An apparatus for deactivating a battery module, the apparatus comprising:
a relay configured to be connected to a first electrode terminal and a second electrode terminal of a battery module;
a fuse circuit configured to be connected to the first electrode terminal and a first electrode of a battery cell array; and
a processor connected to the relay and the fuse circuit,
wherein, when a preset condition is satisfied, the processor is configured to control the fuse circuit to block a current path between the first electrode terminal and the first electrode and short the relay.

2. The apparatus of claim 1, wherein the first electrode has the same polarity as the first electrode terminal.

3. The apparatus of claim 1, wherein the fuse circuit includes:
a fuse configured to be connected to the first electrode terminal and the electrode;
a capacitor in which a voltage is stored; and
a switch element connected to the fuse and the capacitor.

4. The apparatus of claim 3, wherein the processor is configured to block the current path by turning the switch element on and applying the voltage stored in the capacitor to the fuse to melt and disconnect the fuse.

5. The apparatus of claim 1, wherein the processor is configured to block the current path upon receiving a module deactivation signal from a battery management system.

6. The apparatus of claim 1, wherein the processor is configured to output a control signal instructing passive balancing for the battery module after shorting the relay.

7. A method of deactivating a battery module, which is performed by a computing device including a processor, the method comprising:
blocking a current path between a first electrode terminal of a battery module and a first electrode of a battery cell array by controlling a fuse circuit connected to the first electrode terminal and the first electrode when a preset condition is satisfied; and
shorting a relay connected to the first electrode terminal and a second electrode terminal of the battery module.

8. The method of claim 7, wherein the first electrode has the same polarity as the first electrode terminal.

9. The method of claim 7, wherein the fuse circuit includes:
a fuse connected to the first electrode terminal and the electrode;
a capacitor in which a voltage is stored; and
a switch element connected to the fuse and the capacitor.

10. The method of claim 9, wherein, the current path is blocked by turning the switch element on and applying the voltage stored in the capacitor to the fuse to melt and disconnect the fuse.

11. The method of claim 7, wherein, the current path is blocked upon receiving a module deactivation signal from a battery management system.

12. The method of claim 7, further comprising, after the shorting of the relay, outputting a control signal instructing passive balancing for the battery module.

13. A battery pack comprising;
a plurality of battery modules; and
a battery management system configured to manage the plurality of battery modules,
wherein the battery management system identifies a target battery module to be deactivated among the plurality of battery modules and outputs a module deactivation signal to the target battery module, and
wherein the battery module is deactivated by being shorted upon receiving the module deactivation signal.

14. The battery pack of claim 13, wherein the target battery module includes:
a relay connected to a first electrode terminal and a second electrode terminal of the battery module;
a fuse circuit connected to the first electrode terminal and a first electrode of a battery cell array; and
a processor configured to control the fuse circuit to block a current path between the first electrode terminal and the first electrode and short the relay when a preset condition is satisfied.

15. The battery pack of claim 14, wherein the first electrode has the same polarity as the first electrode terminal.

16. The battery pack of claim 14, wherein the fuse circuit includes:
a fuse connected to the first electrode terminal and the electrode;
a capacitor in which a voltage is stored; and
a switch element connected to the fuse and the capacitor.

17. The battery pack of claim 16, wherein the processor blocks the current path by turning the switch element on and applying the voltage stored in the capacitor to the fuse to melt and disconnect the fuse.

18. The battery pack of claim 14, wherein the processor outputs a control signal instructing passive balancing for the battery module after shorting the relay.
